(19) United States
(12) Patent Application Publication
(10) Pub. No.: US 2002/0038239 A1
(43) Pub. Date: Mar. 28, 2002

(54) Coupon issue system

(76) Inventors: Takashi Hasegawa, Tokyo (JP); Yoshihiko Taguchi, Tokyo (JP)

Correspondence Address: ARENT FOX KINTNER PLOTKIN & KAHN, PLLC, Suite 600, 1050 Connecticut Avenue, N. W., Washington, DC, 20036-5339, US

(21) Appl. No.: 09/817,237

(22) Filed: Mar. 27, 2001

(30) Foreign Application Priority Data
Sep. 22, 2000 (JP) 2000-288251

(51) Int. Cl. G06F 17/60

(52) U.S. Cl. 705/14

(57) ABSTRACT

A coupon issue system capable of issuing a coupon to grip a customer appropriately is provided. The coupon issue system issuing the coupon to a predetermined person via the Internet, which comprises a coupon issue information means guiding goods to be applied and informing the predetermined person that the coupon is issued based on an issue candidate list by e-mail, a coupon issue request receipt means receiving request to issue the coupon from a respondent who responds to this information, and a coupon issue means issuing the coupon to the respondent who requests to issue the coupon such that value of the coupon is to be different.

### FIELD OF THE INVENTION

The present invention relates to a coupon issue system to issue a coupon to a predetermined person.

### BACKGROUND OF THE INVENTION

Conventionally, a coupon is often used in the dealings of goods or services. The coupon serves as a discount ticket, a complimentary ticket, and a gift exchange certificate. Some of coupons are mentioned in advertisement inserted into a newspaper or a magazine and a booklet like a coupon book. Users of these coupons can receive a discount service such as object goods for this coupon, for example, by taking a tucked advertisement to a shop.

A coupon used after being distributed (stored) as electric information and being printed with a printer is known. For example, Japanese Laid open publication No. H11-346352 discloses “Coupon generation apparatus, server apparatus, and receiver” in which the coupon is printed with a printer at home by using a broadcast wave such as a television. And Japanese Laid open publication No. H11-328269 discloses “Electric coupon system, and electric coupon issue and inspection method” capable of detecting forgery or alternation of the coupon, or illegal use of the coupon by the third party even when an electrically issued coupon is printed and used. Moreover, for example, Japanese Laid open publication No. H11-203558 discloses “Coupon issue system” in which a predetermined point is sequentially added to a customers' magnetic card (or flash memory card) and the accumulated point is recorded by a coupon issue machine; the coupon is issued from the coupon issue machine when the accumulated point reaches a reference point; and the reference point is subtracted from the accumulated point and the balance point is recorded on the magnetic card.

And a coupon; electronized not through the aforementioned paper coupon, namely, issued/distributed as electric information and used as electric information is known. For example, Japanese Laid open publication No. H11-16053 or U.S. Pat. No. 5,380,991 etc. discloses the coupon used an IC card. “Method of using electric coupons and system for using thereof” in Japanese Laid open publication No. H11-16053 comprises a server apparatus on the provider side of the coupon service, a terminal apparatus on the user side of coupon service, and an IC card to store a coupon (electric coupon); and automatically selects the applicable coupon when the goods and services are purchased, and uses the coupon. In addition, an appropriate coupon is extracted in preparation for the purchase of the following goods and services and the coupon is provided the user of the coupon service.

By the way, when the coupon is issued so that the value of the coupon is different even if the coupon which can purchase the same good, coupon users' interest can be invited. For example, an electric coupon in U.S. Pat. No. 5,380,991 previously records a purchase history on the IC card and changes a discount rate according to the history. Further, the homepage of the patent office published in July, 2000 discloses a technology that when shopping by mail order on the Internet (passive), the ten times coupon is distributed at the rate of once every 20 times.

However, the electric coupon of U.S. Pat. No. 5,380,991 is to be issued based on a past purchase history. Therefore, this electric coupon is not necessarily appropriate for new customers' invitation when thinking about the case to invite new customers as the coupon being the motive. Moreover, there is no interest that ten times coupons is passively drawn at the rate of once every 20 times. Since the privilege of ten times coupons cannot be received if the good etc. are not actually purchased, the effect to grip new customers is not necessarily strong.

### SUMMARY OF THE INVENTION

This invention has been made to solve the above problems, and it is therefore the main object of the present invention is to provide with a coupon issue system, which is capable of issuing the coupon strongly to grip the customer appropriately.

Another object of the present invention is to provide with a coupon issue system for issuing a coupon to a predetermined person via a communication means which comprises:

a coupon issue information means for guiding goods to be applied and for informing the predetermined person that the coupon is issued;

a coupon issue request receipt means for receiving request to issue the coupon from a respondent who responds to information; and

a coupon issue means for issuing the coupon to the respondent who requests issue such that the value of the coupon is to be different.

In this configuration, the coupon is issued to a predetermined person (respondent) that coupon issue is requested according to information which the coupon is issued. The value of the coupon is to be different when issuing the coupon, hereby there are respondents to whom the coupon with high value is issued and respondents to whom the coupon with low value is issued, and therefore the respondents' interest can be invited. Note that the respondent who requests to issue the coupon is a person who desires the coupon more since goods are guided when informing that the coupon is issued (person that possibility of intention to purchase goods to be applied by using the coupon is high). Therefore, the person who issues the coupon can issue it appropriately. Here, not only a simple guide like “Can of coffee which the price is 120 yen” or “Lunch box at ∘Δ convenience shop (400 yen or more)” but also a guide indicating the explanation of the goods in detail might be accepted as the guide of the goods. That is, the predetermined person can discriminate what the object of the coupon is.

And, the predetermined person having possibility of becoming the respondent (the predetermined person whom information of coupon issue is received) is not limited to a person who actually purchased the goods (in a case of purchasing) in the present invention. This point is to differ from that of a prior art in which only the person who actually purchased the goods (in a case where purchase was conducted) can get the privilege. Further, a configuration; in which the more purchased history the respondent has, the easier issue the coupon with a high value is; may be accepted based on a past purchase history at the time when the coupon is actually issued.

Further another object of the present invention is to provide with the coupon issue information means has a configuration in which information is conducted based on an issue candidate list to specify the predetermined person.

According to this configuration, information of the coupon issue by the person who issues the coupon so as to limit to a person who desires the purchase more becomes available. Here, that the configuration is to make the issue candidate list by taking hobby, preference, age, family composition, and annual income, etc. into consideration and is to inform the coupon issue based on the list is preferable without causing uselessness on information. Moreover, it is preferable to make the issue candidate list limited to the person who does not have purchase history, if new customers are obtained.

Furthermore, “Coupon issue information” is conducted by the homepage which the coupon issue system opens on the Internet (screen linked to this homepage) in the first embodiment of the present invention mentioned hereinafter. “Predetermined person” at this time is a person who looks at this homepage. In the second embodiment, “Coupon issue information” is conducted by e-mail in which the coupon issue system transmits based on the issue candidate list. “Predetermined person” at this time is a person mentioned on the issue candidate list. Further, it is meant that “Coupon issue means” includes a coupon issue means in which the coupon value is to be different and which value is issued to which respondent is determined (issue destination list is made), and the actual issue thereafter is not limited to the specific means/method. Furthermore, “Coupon is issued to the respondent who requests to issue the coupon such that value of coupon is different” means that which coupons' value is issued is hidden from the respondent and the coupon is issued to a person who requests to issue the coupon (issuing the coupon by lottery is preferable from the viewpoint of fair).

### BRIEF DESCRIPTION OF THE DRAWINGS

FIG. 1 is a block diagram showing whole coupon issue system in the first embodiment.

FIG. 2A shows the issue condition set file of a logical configuration view of a kind of file used in the first embodiment.

FIG. 2B shows a destination list.

FIG. 3A shows a view showing configuration example of coupon lottery screen linked to homepage which the coupon issue system in the first embodiment opens.

FIG. 3B shows a view showing configuration example of coupon issue confirmation screen.

FIG. 4 is a flow chart to explain outline operation of the coupon issue system in the first embodiment.

FIG. 5 is a sequence chart to explain operation of coupon issue server and information terminal in the coupon issue system of the first embodiment.

FIG. 6 is a block diagram showing whole coupon issue system in the second embodiment.

FIG. 7A shows issue condition set file of the logical configuration view of a kind of file used in the second embodiment.

FIG. 7B shows the list of issue candidate list.

FIG. 7C shows the issue destination list.

FIG. 8A shows a view showing configuration example of coupon lottery screen linked to the homepage which the coupon issue system in the second embodiment opens.

FIG. 8B shows a view showing configuration example of coupon issue confirmation screen.

FIG. 9 is a flow chart to explain outline operation of the coupon issue system in the second embodiment.

FIG. 10 is a sequence chart to explain operation of the coupon issue server and information terminal in the coupon issue system of the second embodiment.

### DESCRIPTION OF THE PREFERRED EMBODIMENT

Below, the embodiment of a coupon issue system in the present invention will be described referring to the drawings.

<<First Embodiment>>

First, the coupon issue system of the first embodiment is described.

The coupon issue system in the first embodiment is that a person who issues the coupon opens a homepage on the Internet and informs that the coupon is issued on this homepage (passive information); issue request from the respondent (a predetermined person) who looks at this homepage and responds to this information is received; lots are drawn by the way of, namely, speed lottery; and the coupon with a different value is individually issued to the respondent.

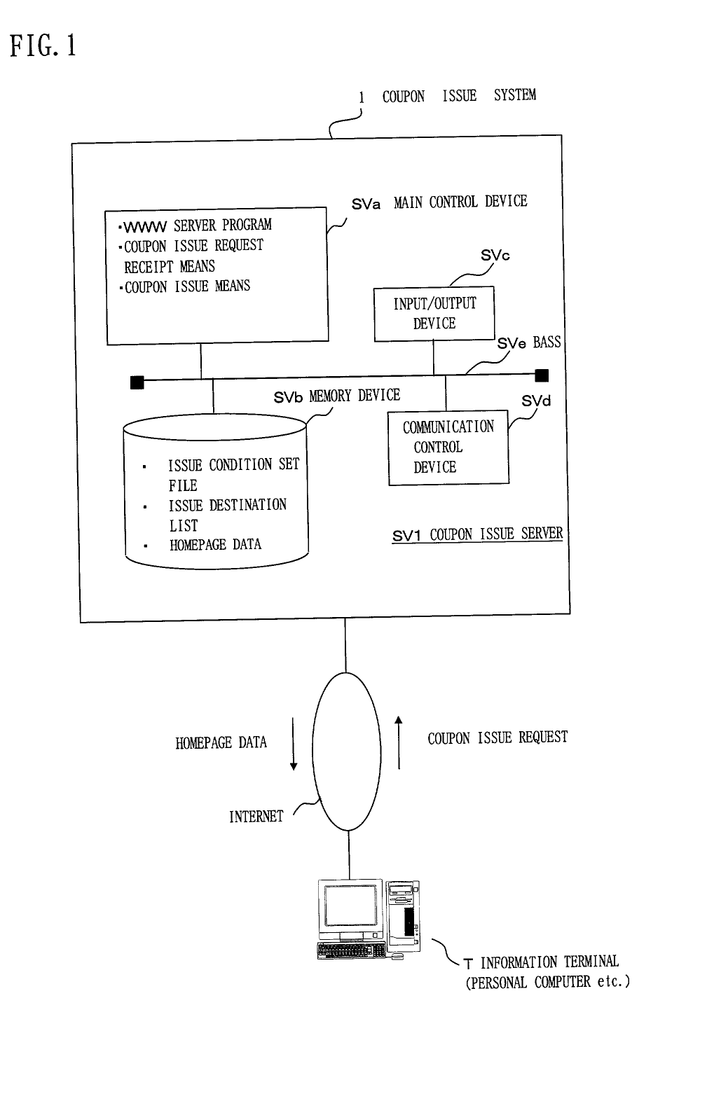

Here, FIG. 1 is a block diagram showing the whole configuration of the coupon issue system of the first embodiment.

[Configuration of First Embodiment]

Coupon issue system 1 is described.

As shown in FIG. 1, coupon issue server SV1 has a configuration in which main control device SVa, memory device SVb, input/output device SVc, and communication control device SVd etc. are connected to bass SVe.

Main control device SVa is configured by MPU (Micro Processing Unit) and RAM (Random Access Memory) etc., and controls coupon issue server SV1 generally. In main control unit SVa, a WWW Server program, a coupon issue request receipt means, and the coupon issue means etc. are started.

Memory device SVb is configured by a hard disk device and an optic magneto disk device, etc. Memory device SVb stores an issue condition set file, issue destination list, and homepage data etc.

A keyboard, a mouse, and a display device, etc. are connected to input/output device SVc via an I/O device. Further, communication control unit SVd is configured by TA (Terminal Adapter) etc., and implements transmission and receipt of information by the Internet.

Each program started in main control device SVa is explained.

The WWW server program is a basement program providing a server or a client (information terminal T) on the Internet with various kinds of information by HTTP (Hyper Text Transfer Protocol) and getting various kinds of information.

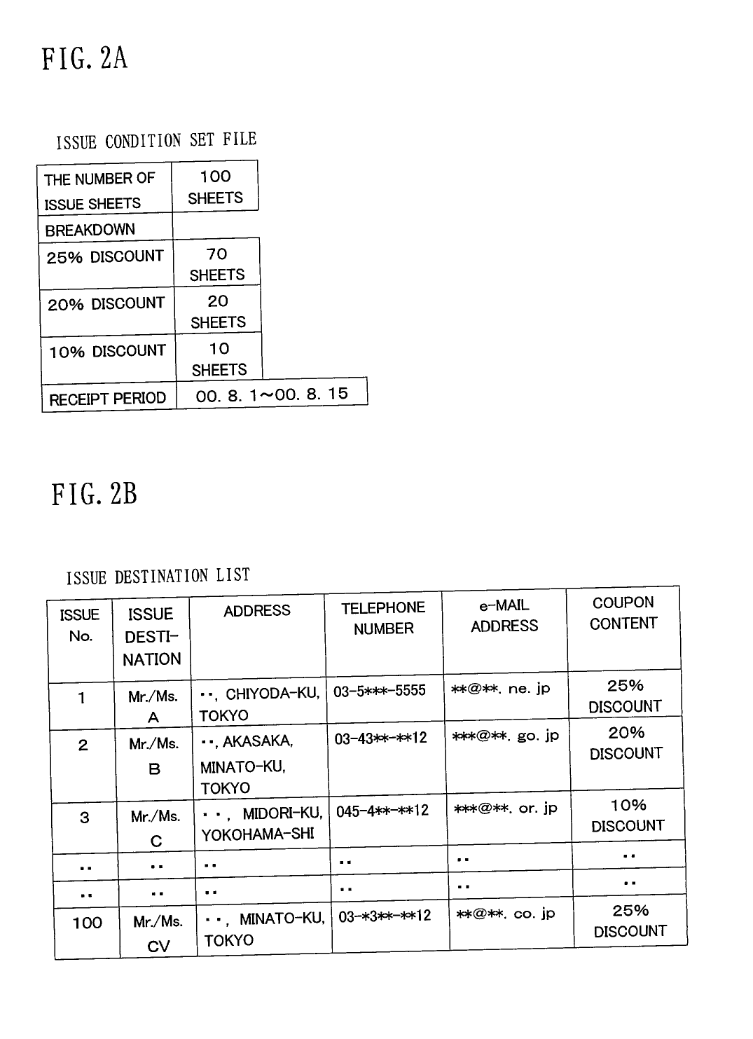

The coupon issue request receipt means is a program to receive request to issue the coupon to be transmitted from information terminal T of a respondent responding to information issuing the coupon. The coupon issue means is a program having (1) a function that value of the coupon being issued is to be different based on an issue condition set file, (2) a function that the coupon is assigned to a respondent based on issue request of a respondent and a destination list (Refer to FIG. 2B) is made, and (3) a function that an issue destination list is output and issue of the coupon is promoted to a person who issues the coupon. Note that the person issues a paper coupon previously made based on this issue destination list by air mail, in the present embodiment.

A file which memory device SVb stores is described referring to FIGS. 2A and 2B (Refer to FIG. 1 adequately).

Here, FIG. 2A shows the issue condition set file of a logical configuration view of a kind of file used in the first embodiment and FIG. 2B shows an issue destination list.

The issue condition set file shown in FIG. 2A has fields of the number of issue sheets, a breakdown, and receipt period. The number of issue sheets is to define a total range of the number of issue sheets for the coupon. The breakdown is to define that the coupon is what kind of privilege and how many coupons should be issued. In this FIG. 2A, 25% discount of the best privilege among the number of 100 sheets to issue is set to 70 sheets, 20% discount is set to 20 sheets, and 10% discount is set to 10 sheets. Namely, this is to be different from value of the coupon.

Here, this issue condition set file is planned based on sale policy by the person who issues the coupon.

The destination list shown in FIG. 2B has fields of the issue No., destination, address, telephone number, e-mail address, and coupon content. This field can be increased and decreased if required. Issue Nos. are from 1 to 100. Namely, there are issue Nos. for the number of issue sheets (100 sheets) of the issue condition set file.

The coupon is issued based on this destination list.

Homepage data is various kinds of data which is necessary in order to implement issue of the coupon by the homepage on the Internet. The homepage data is made by HTML (Hyper Text Markup Language) type.

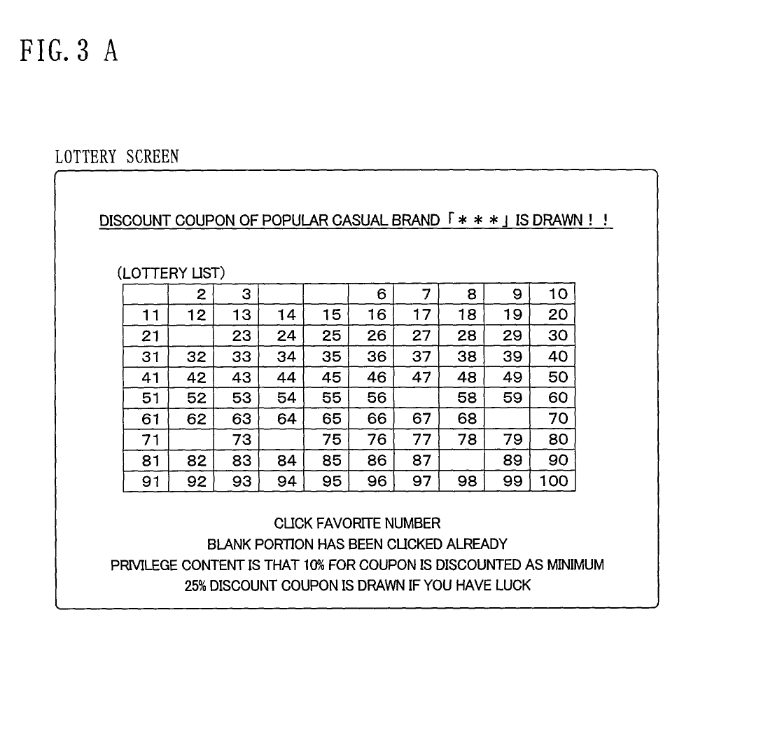

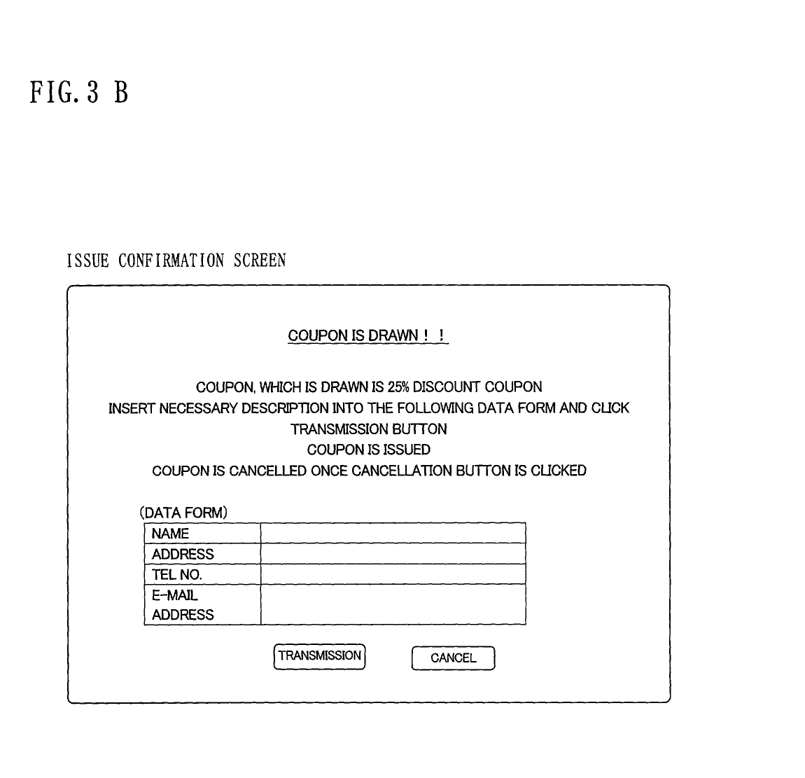

The homepage which coupon issue system 1 opens on Internet is described referring to FIGS. 3A and 3B (Refer to FIGS. 1 and 2 appropriately). Here, FIG. 3A is a view showing the configuration example of a coupon lottery screen. FIG. 3B is a view showing the configuration example of a coupon issue confirmation screen.

The lottery screen shown in FIG. 3A is a screen linked to the homepage (not shown). This lottery screen has a role to guide the goods to be applied and to inform that the coupon is issued (role as the coupon issue information means), a role receiving the request to issue the coupon. At the same time, the value of the coupon is to be different by lottery. The lottery screen has role to apply the coupon to the respondent who requests to issue the coupon. Here, the heading portion of the lottery screen corresponds to the coupon issue information to guide the goods to be applied and to inform that the coupon is issued.

100 sheets of coupons of 10% discount to 25% discount in the lottery list are respectively applied to numbers based on the issue condition set file in FIG. 2A at random. And once the respondent clicks the mouse for each number of the lottery list, number selection signal which corresponds to the number for which the mouse was clicked is transmitted to coupon issue server SV1 and the coupon which is applied to the number is issued to the respondent who clicks the mouse (request to issue the coupon). Further, data is updated such that the number for which the mouse is clicked once is deleted from a screen and the number will not be displayed on the screen of any information terminal T afterward. Thereby, the mouse for the same number is not clicked again. Further, the same coupon lottery screen is not displayed on information terminal T used for drawing the lottery once by using a terminal attestation means with a cookie to prevent to draw the lottery from the same information terminal T again (issue request).

Here, the coupon issue means makes the lottery list based on the issue condition set file.

The issue confirmation screen shown in FIG. 3B is a screen linked to the coupon lottery screen, informs the respondent who drew the lottery the result of lottery, and has a data form, a determination button, and a cancellation button to assure issue of the coupon.

The name, address, telephone number, and e-mail address of the respondent who drew the lottery are to be written on the data form. And the determination button is a button for transmitting the data form to coupon issue server SV1. The cancellation button is a button to use when coupon issue is canceled. Once the mouse for this button is clicked, the number selection signal transmitted by clicking the mouse for the number on the aforementioned lottery list is cancelled and the number for which the mouse is clicked is displayed again. The same lottery screen is not displayed from the same information terminal T by the aforementioned cookie again. This is to avoid clicking the mouse for the number and the cancellation button on the lottery list by the same person who intends to get the coupon of discount with high rate.

The destination list in FIG. 2B is made based on the transmitted data form and the result of lottery by the lottery list.

Here, information terminal T of the respondent is a usual personal computer and the WWW browser program is installed therein.

[Operation of First Embodiment]

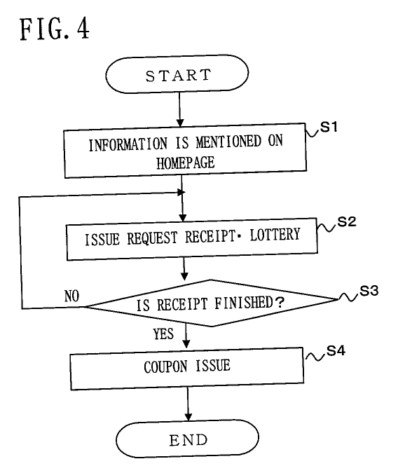

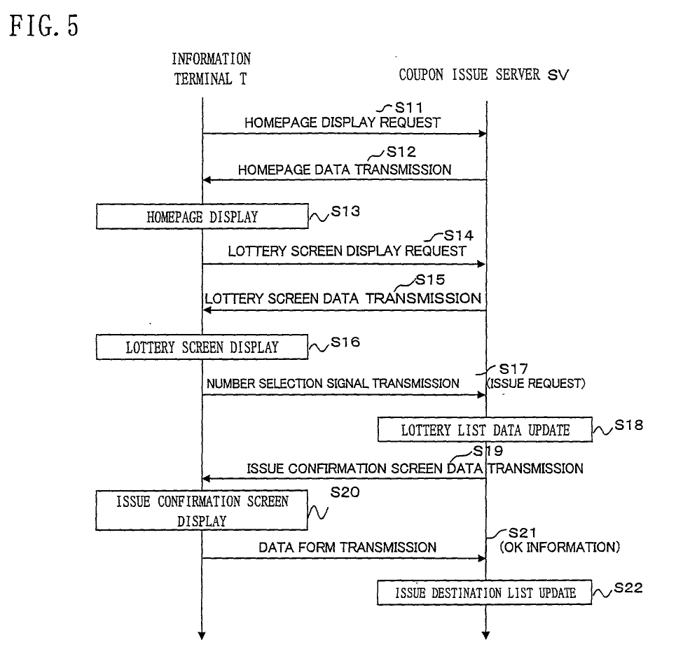

Next, operation of aforementioned coupon issue system 1 is described referring to FIGS. 4 and 5 (Refer to FIGS. 1 to 3 appropriately).

Here, FIG. 4 is a flow chart to explain outline of the coupon issue system in the first embodiment. FIG. 5 is a sequence chart to explain operation of the coupon issue server and information terminal in the coupon issue system of the first embodiment.

Outline operation of coupon issuing system 1 is described referring to FIG. 4.

First, coupon issue system 1 guides the goods to be applied and informs the homepage that the coupon is issued at step 1 (information is mentioned, information may be conducted by a newspaper, magazine or flier etc.).

Receipt of issue request and lottery from the respondent are made by the lottery screen (lottery list) shown in FIG. 3A and the issue confirmation screen shown in FIG. 3B at step 2 (issue destination list shown in FIG. 2B is made and updated). Furthermore the lottery screen serves as coupon issue request receipt means and coupon issue information means to inform that the coupon is issued.

At step 3, whether or not issue request, for the number of sheets to issue defined in the issue condition set file in FIG. 2A is received and whether or not receipt period is expired are judged, and then return to the step 2 and receipt of issue request/lottery are continued when request to issue for the number of issue sheets is not received in a receipt period. The coupon is issued based on the destination list at step 4 when issue request for the number of issue sheets is received or when receipt period is expired.

Next, operation of coupon issue server SV1 and information terminal T are described referring to FIG. 5. This operation corresponds to that of step 2 in the flow chart of FIG. 4.

First, display of the homepage is required since the respondent accesses the homepage in coupon issue system 1 (S11). Coupon issue server SV1 transmits the homepage data to information terminal T based on this request (S12). Thereby, the homepage is displayed on information terminal T. A respondent clicks the mouse for the display button of the lottery screen pasted to the homepage (not shown) to display the lottery screen shown in FIG. 3A. Thereby, request to display the lottery screen is transmitted (S14). Coupon issue server SV1 transmits the lottery screen data to information terminal T according to this request (S15). At step S16, the respondent clicks the mouse for one of numbers displayed on the lottery list once lottery screen T is displayed on information terminal T. Then, the number selection signal is transmitted to coupon issue server SV1 as issue request to issue the coupon. Coupon issue server SV1 supplies the coupon assigned to the number whose the mouse is clicked to the respondent according to receipt of this signal and updates data to delete the number whose the mouse is clicked from the lottery list (S18). And the issue confirmation screen data is transmitted to information terminal T to display the issue confirmation screen shown in FIG. 3B on information terminal T (S19).

At step 20, necessary description inserted into the data form by the respondent and the respondent clicks the mouse for the transmission button once the issue confirmation screen is displayed on information terminal T. Then, the data form is transmitted to coupon issue server SV1 as coupon OK information (S21). By this transmission, coupon issue server SV1 updates the issue destination list shown in FIG. 2B (S22). And the coupon is issued based on the issue destination list (predetermined paper coupon previously made based on the issue destination list is issued by a person who issues the coupon by air mail).

In the first embodiment, the coupon is issued in such a manner. Further, in the first embodiment, while a lot of coupons with the high discount rate is issued, detail that which discount rate and how many sheets there are coupons is not opened, and therefore satisfaction by many respondents got the coupon with the high discount rate is obtained. And since the coupon privilege (value) is determined by operation of the person who receives the coupon, pleasure of a game sense can be obtained and it becomes a test of luck.

Here, any of an electrically issued coupon and a coupon printed on paper is acceptable as the coupon in the first embodiment. And any of issue form and use way of the coupon is accepted. For example, that the coupon is issued by using an electric means as mentioned in Japanese patent application No. 2000-269962 filed by the present applicant and the coupon is used by the electric means may be accepted.

<<Second Embodiment>>

Next, the coupon issue system of the second embodiment is described.

The coupon issue system of the second embodiment is that the person who issues the coupon opens the homepage on the Internet. The coupon issue system informs the predetermined person that the coupon is issued based on the issue candidate list made separately by e-mail (positive information). The coupon issue system is that issue request from the respondent who responds to this information is received; and the coupon with different value is issued to the respondent individually by drawing a number by the way of so-called speed lottery.

Elements which are the same as those in the first Embodiment have the same signs and their descriptions will be omitted.

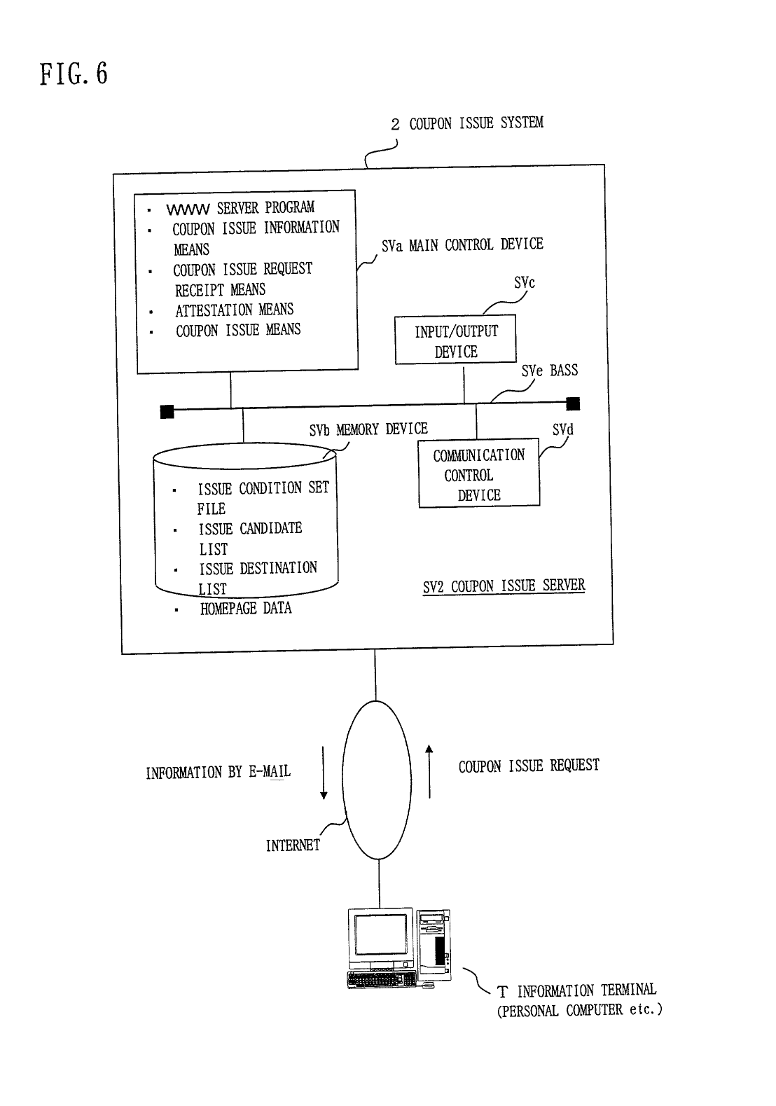

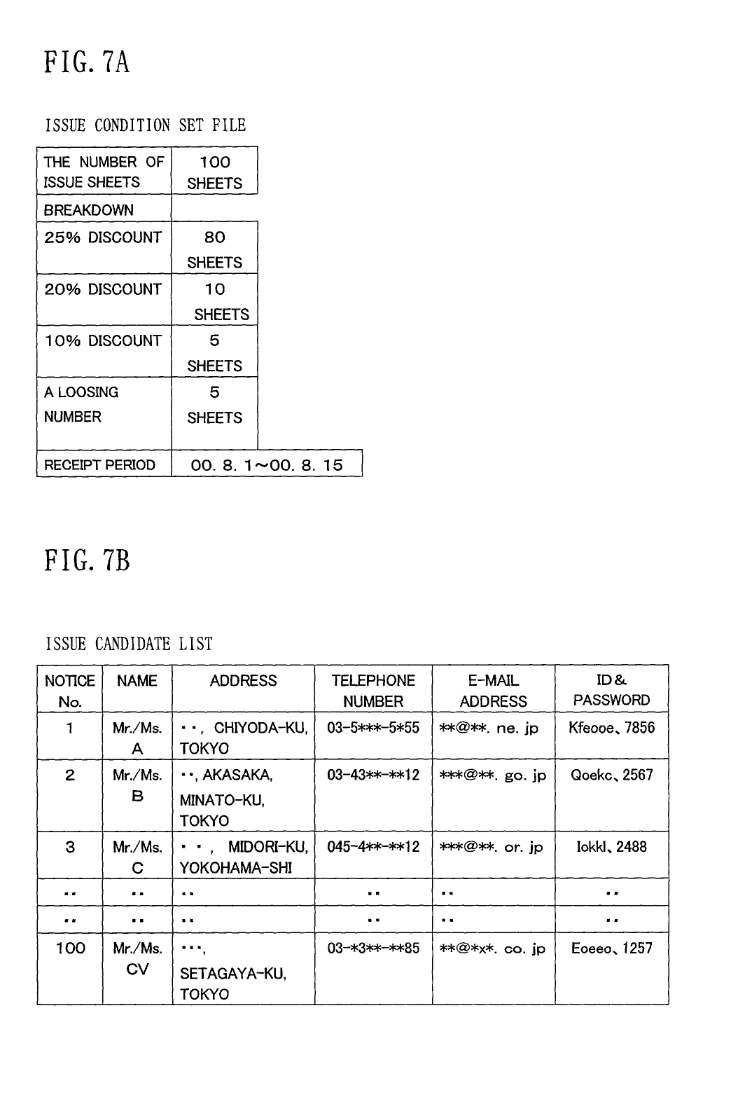

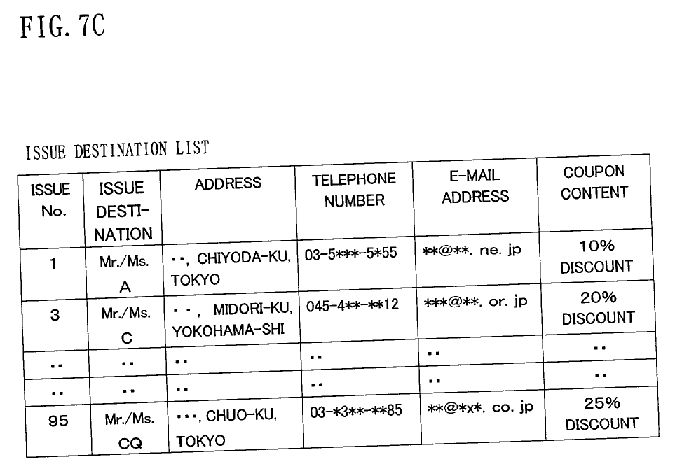

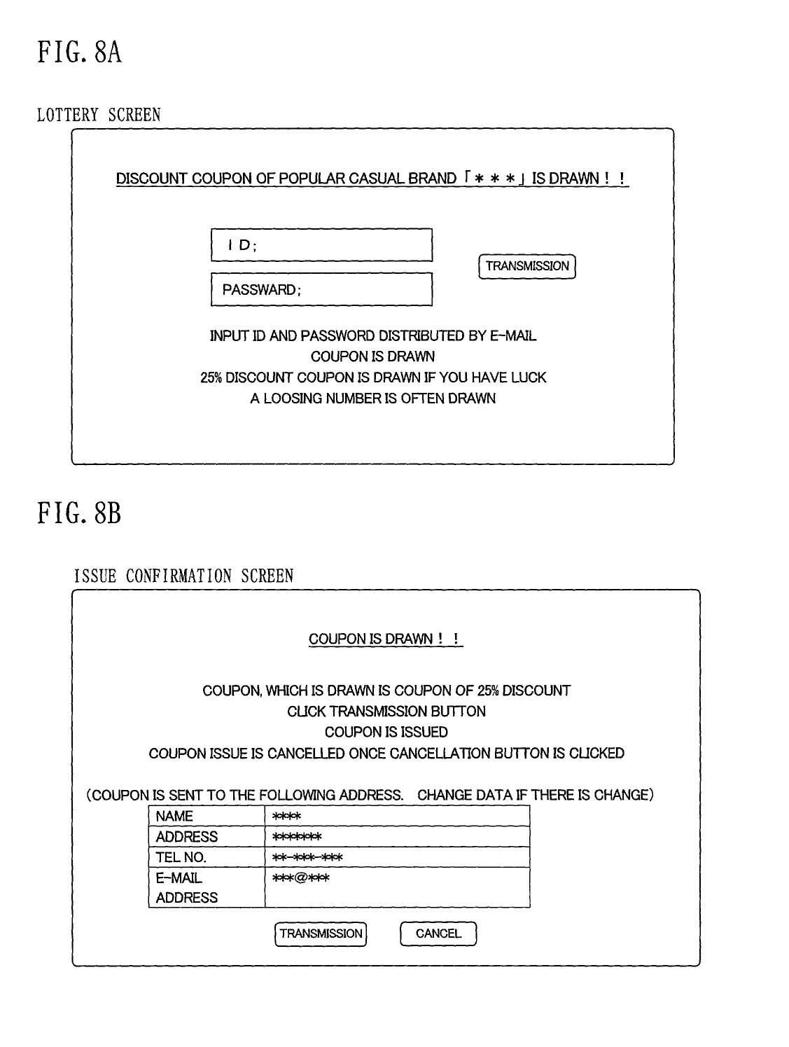

Here, FIG. 6 is a block diagram showing whole configuration of the coupon issue system of the second embodiment. FIG. 7A shows the issue condition set file of a logical configuration view of a kind of file used in the second embodiment. FIG. 7B shows the issue candidate list. FIG. 7C shows the issue destination list. FIG. 8A is a view showing the configuration example of the coupon lottery screen and FIG. 8B is a view showing the configuration example of the coupon issue confirmation screen.

[Configuration of Second Embodiment]

Coupon issue system 2 is described.

As shown in FIG. 6, coupon issue server SV2 has a configuration in which main control device SVa, memory device SVb, input and output device SVc, and communication control device SVd etc. are connected to bass SVe in the same manner of coupon issue server SV1 in the first embodiment.

In the second embodiment, the coupon issue information means that information to issue the coupon is sent as e-mail and an attestation means which attestates to the respondent are started in main control device SVa. And the issue candidate list to where e-mail is sent is stored in memory device SVb.

A losing number is set in the issue condition set file of FIG. 7A. This point is to differ from that of the first embodiment. The name of the same number of issue candidate persons as the number of sheets to issue the issue condition set file together with e-mail address or ID and password are mentioned on the issue candidate list of FIG. 7B. It is preferable that this issue candidate list is made taking into account of age, sex, hobby, family composition, annual income of an issue candidate. Further, the name of the issue candidate drawn a winning number as the result of lottery together with coupon content are mentioned on the issue destination list of FIG. 7C.

Coupon issue information is a document sent to the issue candidate who receives the coupon issue as e-mail. Description which the coupon is drawn in the lottery once a user accesses the homepage of coupon issue system 2, and ID and the password indicated on coupon issue information are input; and guide of the goods being applied for the coupon (40% of price ** of DVD-RAM produced by ⊚Δ corp. or ** yen is discounted as maximum) are mentioned on this coupon issue information.

Coupon issue system 2 opens the homepage on the Internet. The lottery screen shown in FIG. 8A is a screen linked to the unshown homepage. This lottery screen has a role for receiving issue request of the coupon. At the same time, the lottery screen has a role for supplying it to the respondent to whom issue is requested such that the value of the coupon is to be different.

A blank to input ID and a blank to input the password are respectively blanks to input ID and the password mentioned on coupon issue information sent as e-mail. Once the respondent respectively inputs ID and the password into blanks and clicks the mouse for the transmission button, any of coupons set based on the issue condition set file in FIG. 7A is drawn as speed lot and the respondent becomes a winner. Note that the coupon issue means draws the lottery.

The issue confirmation screen shown in FIG. 8B is a screen linked to the coupon lottery screen, informs the respondent who draws the lottery the result of lottery, and has a determination button to assure issue of the coupon and a cancellation button to cancel issue of the coupon.

The data form to use when the respondent confirms an address and the address is different or the respondent desires to change the address is provided on this issue confirmation screen. The determination button and the cancellation button are buttons to confirm of respondents' will, and whether or not the issue candidate list is finally made (whether or not the list is updated) is determined based on the put button.

[Operation of Second Embodiment]

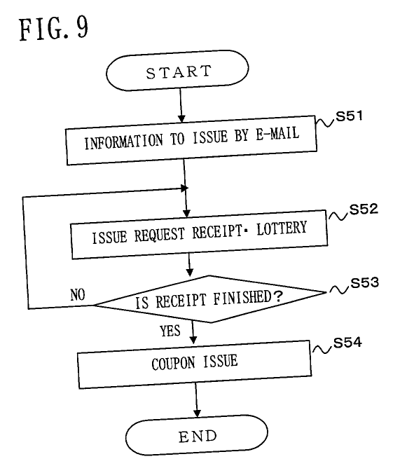

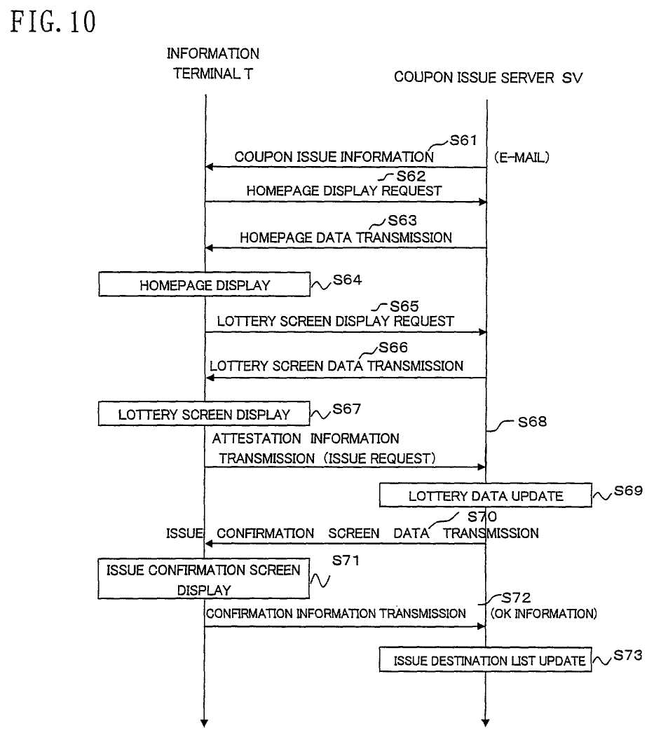

Next, operation of aforementioned coupon issue system 2 is described referring to FIGS. 9 and 10 (Refer to FIGS. 6 to 8 appropriately).

Here, FIG. 9 is a flow char to explain outline operation of the coupon issue system in the second embodiment. FIG. 10 is a sequence chart to explain operation of the coupon issue server and the information terminal in the coupon issue system of the second embodiment.

Outline operation in coupon issue system 1 is described referring to FIG. 9.

First, coupon issue system 1 informs that the coupon is issued based on the issue candidate list by e-mail at step 51.

Issue request from the respondent is received and the lottery is drawn by the lottery screen shown in FIG. 8A and the issue confirmation screen shown in FIG. 8B at step 52 (The issue dedicate list shown in FIG. 7C is made and updated).

At step 53, whether or not request to issue, for the number of issue sheets defined in the issue condition set file in FIG. 7 A is received, and whether or not receipt period is expired is judged and then return to step 52 and receipt of issue request and lottery are continued when issue request for the number of issue sheets is not received in receipt period. The coupon is issued based on the issue dedicate list at step 4 when issue request for the number of issue sheets is received or when receipt period is expired.

Next, operation of coupon issue server SV2 and information terminal T are described referring to FIG. 10. This operation corresponds to one of step 52 in the flow chart of FIG. 9.

First, coupon issue server SV2 sends coupon issue information to the predetermined person mentioned on the list based on the issue candidate list by e-mail (Refer to FIG. 7B) (S61). Content of the coupon, unique ID and password needed when issue of the coupon is required; and URL (Uniform Resource Locator) of the homepage in coupon issue system 2 are mentioned on this coupon issue information.

URL is input to information terminal T (URL of coupon issue information for which the mouse is clicked) and displaying the homepage is requested (S62) when a predetermined person (respondent) who looks at this coupon issue information intends to issue the coupon. Coupon issue server SV2 transmits the homepage data to information terminal T according to this demand (S63). Hereby, the homepage is displayed on information terminal T. The respondent clicks the mouse for the display button of the lottery screen pasted to the homepage (not shown) to display the lottery screen shown in FIG. 8A. Hereby, request of the lottery screen display is transmitted (S65). Coupon issue server SV1 transmits the lottery screen data to information terminal T according to this demand (S66).

At step 67, the respondent inputs ID and the password mentioned on coupon issue information to the ID input blank and the password input blank, and clicks the mouse for the transmission button once the lottery screen is displayed on information terminal T. Then, attestation information is transmitted to coupon issue server SV2 as issue request of the coupon. Coupon issue server SV2 attests according to this attestation information and applies a predetermined coupon to the respondent by a lottery function based on a random number once attested. At the same time, the lottery data is updated and the coupon is issued along the issue condition set file of FIG. 7A (S69). And coupon issue server SV2 transmits the issue confirmation screen data to information terminal T to display the issue confirmation screen on information terminal T shown in FIG. 8B (S70).

At step 71, the respondent changes description such as the address of the data form if required and clicks the mouse for the transmission button once the issue confirmation screen is displayed on information terminal T. Then, information of OK is transmitted to coupon issue server SV2 (S72). Upon receiving this transmission, coupon issue server SV2 updates the issue destination list shown in FIG. 2B (S73). And the coupon is issued based on the issue destination list in the same manner as the first embodiment.

In the second embodiment, the coupon is issued based on the issue candidate list in such a manner. Hereby, it becomes possible to issue the coupon preferably to introduce business policy of the issue the person who issues the coupon. And it is possible to increase satisfaction of a lot of respondents who draws the winning number without disclosing detail of the number of sheets to draw a losing number while setting an extremely few drawn a losing number like the second embodiment (possibility of the coupon being used becomes high). Here, “Coupon is issued to the respondent who requests to issue such that the value of the coupon is different” described in the title: “What is claimed” of the present specification includes that the losing number like the second embodiment is set and the coupon is not issued when drawing the losing number, and it is narrowly not interpreted.

Note that any of the electric and paper coupons in the second embodiment is acceptable in the same manner as the first embodiment. And any of the way of the use is acceptable. Further, any of the way of setting the discount rate is acceptable.

Although the preferable embodiment of the present invention (the first embodiment and the second embodiment) is described in detail, the present invention is not limited to the aforementioned embodiments, and it can be broadly changed and implemented.

For example, the coupon may be sequentially issued every lottery. As for the way of the lottery, the coupon may be issued so as to mix an electric roulette or a game etc., for example, the coupon with high discount rate may be issued to the respondent with high scare in the game. That is, not only luck of the respondent but also ability of the respondent may be reflected to issue of the coupon. And, the coupon with the high discount rate is easily drawn to the respondent which period from the coupon issue information to issue request is short and purchasing intention of a respondent may be reflected to issue the coupon. Furthermore, although the configuration in the aforementioned embodiments is a configuration to draw the lottery such the speed lottery every issue request, it may be configured so as to draw the lottery once in a state issue is all requested.

Further, each procedure and each working in the aforementioned embodiments can appropriately be replaced with manual working. For example, coupon issue information may be sent by air mail such as direct mail and coupon issue may be informed by a flier or a tissue got on the street. And the lottery may be drawn by hand.

And of course, a cellular phone or PDA (Personal Data Assistants) having an Internet connection function may be accepted as communication terminal T. Rather, when development and spread of information terminal T of a mobile system such as cellular phone or PDA etc. in the future is considered, the present invention is preferably applied to the cellular phone etc.

Note, the coupon includes a point in the invention. In this case, “Value is high (discount rate is high)” corresponds to “A point number is lots”. “Value is low (discount rate is low)” corresponds to “A point number is a few”.

As mentioned above, according to the claim 1 in the present invention, the coupon is issued to the predetermined person (respondent) who responds to the coupon issue information. Naturally, the person having high purchasing intention for goods to be applied frequently responds. Accordingly, issue of the coupon is to contribute to sales of the goods greatly. And it is easy to pay attention by issuing the coupon such that the value of the coupon (discount rate) is different. And it is possible for the respondent to obtain great satisfaction by issuing the coupon with high value (possibility that the coupon is used becomes high). The coupon with high value is issued to the respondent who responds for the first time (person not having purchase history). Therefore, the coupon system is that the coupon with gripping a lot of customers (gripping customer for both new customers and old customers) can appropriately be issued according to the present invention.

And according to claim 2 in the present invention, coupon issue information to limit to the person with higher purchasing intension for the good by the person who issues the coupon becomes possible. Therefore, it is possible to issue the coupon more adequately.

What is claimed is:

1. A coupon issue system for issuing a coupon to a predetermined person via a communication means, comprising:
a coupon issue information means for guiding goods to be applied and for informing the predetermined person that the coupon is issued;
a coupon issue request receipt means for receiving request to issue the coupon from a respondent who responds to information; and
a coupon issue means for issuing the coupon to the respondent who requests issue such that value of the coupon is to be different.

2. A coupon issue system as set forth in claim 1, wherein the coupon issue information means has a configuration for informing based on an issue candidate list to specify the predetermined person.
